(19) United States
(12) Patent Application Publication
(10) Pub. No.: US 2025/0266724 A1
(43) Pub. Date: Aug. 21, 2025

(54) SPLIT ELECTRIC MACHINE

(71) Applicant: Kongsberg Maritime AS, Kongsberg (NO)

(72) Inventors: Kjell Andreas ERSDAL, Bønes (NO); Paul Fredrik GJERPE, Oslo (NO)

(73) Assignee: Kongsberg Maritime AS, Kongsberg (NO)

(21) Appl. No.: 18/859,336

(22) PCT Filed: May 31, 2023
(86) PCT No.: PCT/NO2023/050127

§ 371 Date: Oct. 23, 2024

(30) Foreign Application Priority Data
Jun. 1, 2022 (NO) 20220630

(51) Int. Cl. H02K 1/28; H02K 11/21; H02K 15/40

(52) U.S. Cl. CPC H02K 1/28; H02K 11/21; H02K 15/40

(57) ABSTRACT

The present invention relates to an electric device for mounting on a rotatable shaft comprising at least two rotor sections being configured to be combined coaxially around the shaft and being mechanically coupled to the shaft so as to constitute a rotor and at least two stator sections with housing, thus being configured to be combined in a coaxial stator configuration around said rotor. The device includes a coupling being fastened in a coaxial configuration to the shaft, the coupling including a flange section extending outward from the shaft, the flange and rotor including matching locking sections so as to connect the rotor to the flange and therefore to the shaft. FIG. 1

This invention relates to a split electric machine, specifically a generator or motor, suitable for installation in existing and new propulsion shafts having a rotating axle.

For some applications like marine vessels there is a need for hybrid propulsion systems where an electric motor or generator can be added to the main propulsion system in order to be operated with or as alternative to the main propulsion system or may constitute the main system. This can be used for reducing fuel consumption and emissions as well as to add flexibility to the system in case of errors. Such as solution is discussed in WO2021/234675 where an electric machine may be connected to the shaft of an existing propulsion system without dismembering existing system.

The machine in WO2021/234675 is constituted by a split assembly with a split rotor that can be mounted around and connected to the propulsion shaft and a split stator/housing connected around the rotor and shaft. The rotor may be connected to the shaft through a collar being fastened to the shaft, where the rotor is rotationally fixed to the collar through provided features. A problem related to this solution is that the rotor becomes fixed to the shaft. If there is an error in the connection between the rotor and stator, e.g. in that there is a stator or connected equipment short circuit, physical contact or touching between stator or rotor, or increased friction between the two, the propulsion system will continue rotating and ruin the complete device or connected equipment.

Thus, there is an object of the present invention to provide an electric machine such as a motor or generator that can be mounted on an existing and/or new propulsion shaft while allowing an extra security if an error occurs in the machine or connected equipment. The mounting process should also be unintrusive and easy, and may also provide a means to monitor the relative rotational position of the shaft, rotor and/or stator in order to control the operation as well as to detect damage or errors in the device as well as assist in failure mitigation and/or reestablish operation. One or more of these objects have been obtained with a device as mentioned above and as specified in the accompanying claims.

Although the discussion below will mainly be based on the use in marine vessel propulsion, other uses may be contemplated, such as motors and generators, generator sets, gear system, thrusters, winches etc. having a rotating shaft or axle with a possibility for connecting a coupling around it.

The invention will be explained in detail below with reference to the accompanying drawings:

FIG. 1 illustrates an overview of the invention connected to a propulsion system.

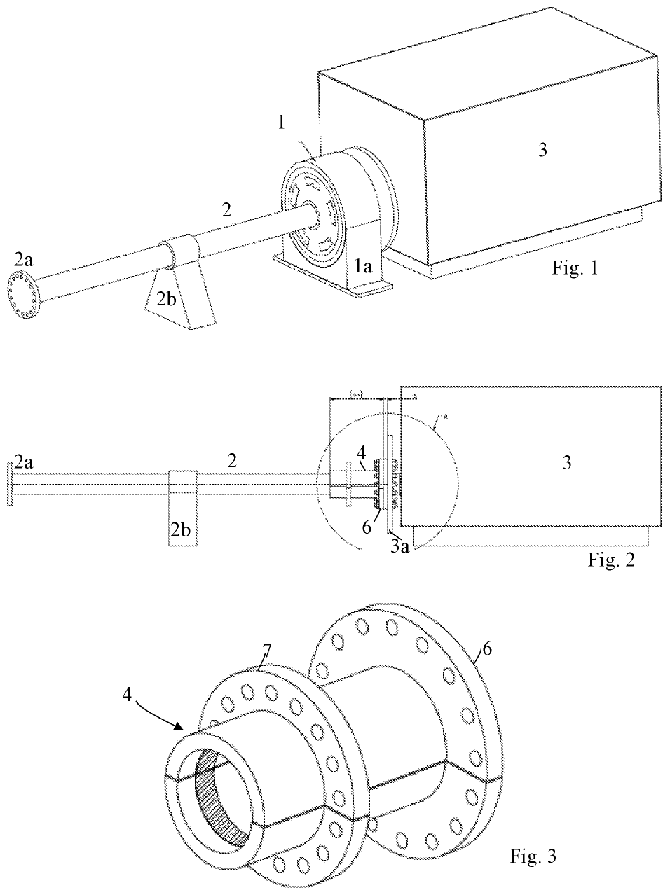

FIG. 2 illustrates a longitudinal section of an embodiment of the position of the coupling according to propulsion system.

FIG. 3 illustrates the coupling according to a preferred embodiment of the invention.

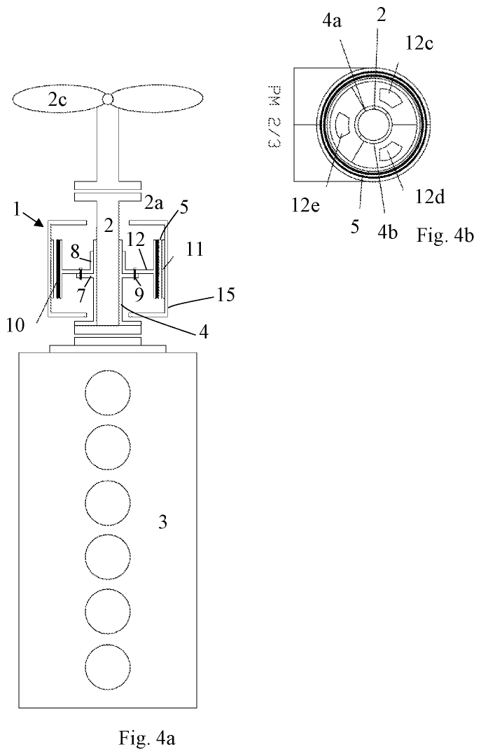

FIG. 4a-b illustrates a first embodiment of the invention.

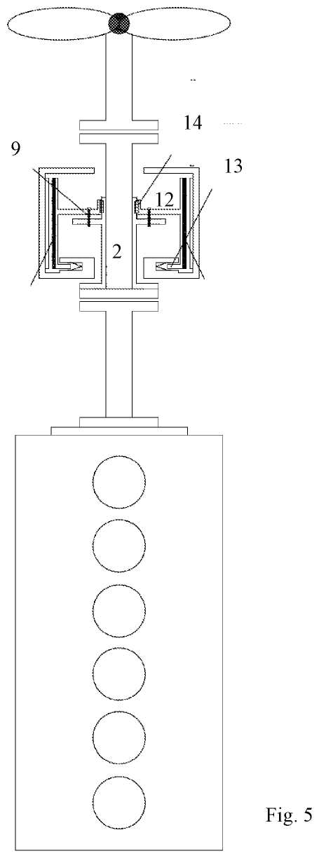

FIG. 5 illustrates a second embodiment of the invention

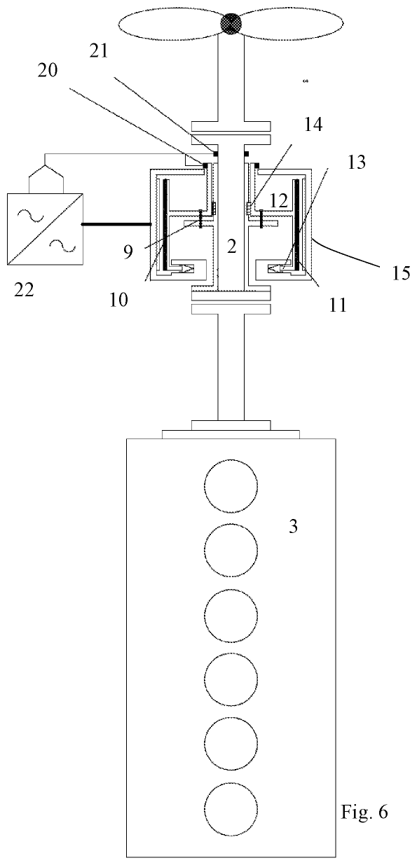

FIG. 6 illustrates a third embodiment of the invention.

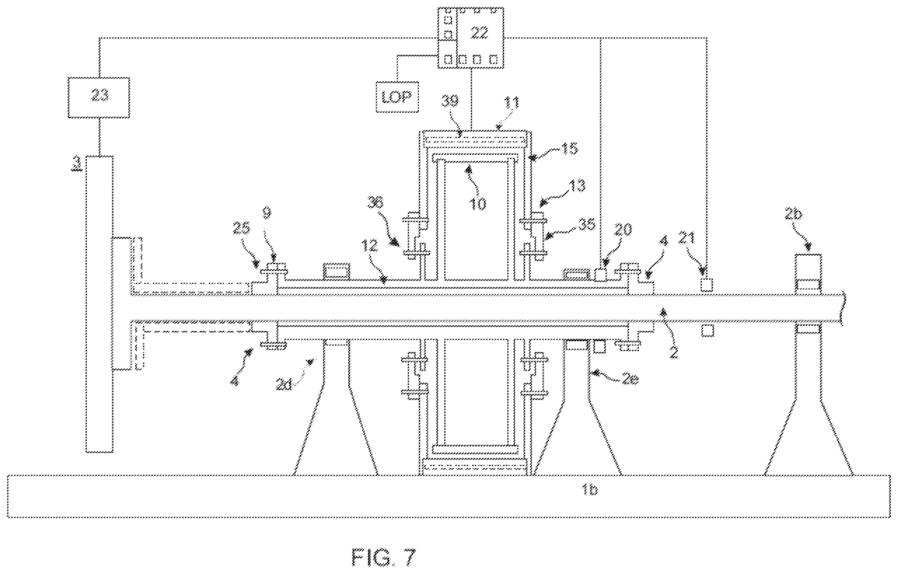

FIG. 7-9 illustrates another embodiment of the invention.

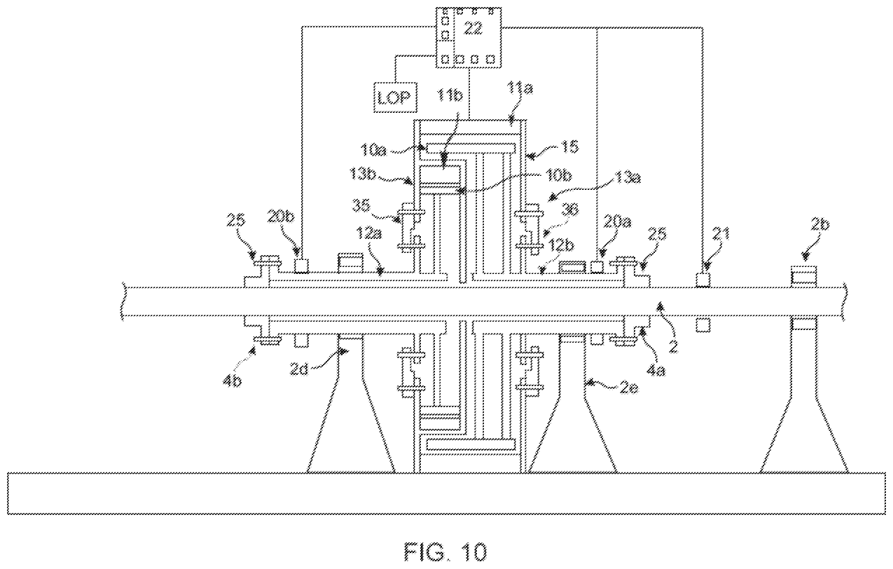

FIG. 10 Illustrates yet another embodiment of the invention.

As illustrated in FIG. 1 the present invention relates to a device, especially a motor or generator, 1 connected to a shaft 2 of a propulsion system, where an engine 3 drives the shaft 2, the shaft also including an end connector 2a, e.g. for connecting to a propellor in a marine vessel. The device 1 according to the invention is mounted on or connected to the shaft 2. In the drawing a shaft support 2b and a generator support 1a, usually including bearings, is also shown.

In FIG. 2 the connection is illustrated and in the shown embodiment a coupling 4 is shown including a first flange 6 to be fastened to a corresponding flange 3a on the shaft 2 or engine 3, locking the coupling 4 rotation to the shaft 2. A splitted flexible coupling may be connected between 2/3a and 6. The connection between the shaft 2 and coupling 4 may alternatively be obtained in numerous ways as is well known in the art.

FIG. 3 illustrates the coupling 4 used in the embodiment shown in FIG. 2, including a first flange 6 for connecting to the shaft or engine, and the coupling also includes a second flange 7. The second flange 7 is configured to be connected to a corresponding part of the rotor of the generator or motor 1 according to the invention, e.g. using bolts, shear pins or actuated shear pins/bolts. The coupling may be provided with a soft metal such as brass, titanium, copper, nickel, aluminum, etc to avoid fretting between the coupling and shaft, and the number of flanges will depend on the implemented solution.

In FIG. 4a an embodiment of the invention is shown where the engine 3 is connected to a propellor 2c through the shaft 2 and connector 2a. The device 1 according to the present invention is shown as a cross section in FIG. 4b where the coupling 4 constituted by two parts 4a,4b is fastened to the shaft 2. The second flange 7 is connected to a corresponding flange 8 on the rotor 12 through a number of pins or bolts 9 (FIG. 4a). In the drawing the rotor flange 8 has a coaxial section extending along the coupling 4. This may stabilize the movement and orientation of the rotor if the pins are broken or disconnected.

In the shown embodiment the rotor 12 is provided with permanent magnets 10 but other solutions will be contemplated by the person skilled in the art, such as externally excited and reluctance salient poles. An outer stator 11 with housing 15 encloses the rotor 12, the rotor and stator being separated with an air gap 5. The stators may be provided with water jacket cooling (39, FIG. 7) as is in known in the art. The rotor and stator configurations may be chosen according to the available solutions or space during retrofitting as long as they may be divided into two or more sections enclosing the shaft 2 and coupling 4.

As mentioned above, each of the coupling, rotor, stator and housing may be constituted by two or more sections being configured to mount on the shaft.

Preferably, the rotor and stator are constituted by three sections of 120 degrees each (e.g. rotor sections 12c, 12d and 12e as shown in FIG. 4b). The respective segments (of the three) are thus coupled together-housing, stator and rotor, each with arrangement for alignment and balancing. This not only eases installation, when space is limited, but the three segments represent three force vectors in 120 degrees angle between the segments, beneficial to balance the dynamic rotational behavior of the rotor. Larger numbers of segments may be contemplated, for the reasons mentioned above preferably a number divisible by a factor of three.

According to the present invention the pins or bolts 9 are configured to break at a predetermined force. This way, at an accident locking the rotation of the rotor and stator, the device may break rotationally free from the shaft 2, thus limiting the damage of the system.

The stator is not shown in detail, but as described above the stator is also constituted by two or more sections, preferably three sections, so as to be mounted around the shaft 2, coupling 4 and rotor 12. The housing 15 is arranged in the same way.

FIG. 5 Illustrates a variation of the embodiment in FIG. 4a, where one or more split bearing 14, preferably being self-lubricating, is arranged between the section of the rotor flange 8 extending along the coupling and the coupling 4, so as to allow them to rotate relative to each other if the pins have been broken. The device may also include a manually or automatically operated brake 13 between the rotor 12 and stator/housing 11 which could be used to lock the rotor or break the pins in some situations. As an alternative the pins or bolts may be broken or connected/disconnected at will.

In FIG. 6 an additional rotary sensor or encoder pair 20,21 integrated with frequency converters 22 synchronizing control algorithms, is provided being capable of detecting and/or monitoring the relative movement between the rotor 12 and the shaft 2, as well as possibly rotor 12 and the coupling 4. This way the position relative to the rotor and shaft/coupling may be controlled or measured in order to stop and start the device. Thus, the movement of the rotor may be initiated or disconnected at a predetermined relative position between the parts. Also, a rotational movement between the rotor and shaft/coupling may be detected, e.g. indicating broken pins, or monitored in order to connect the pins at the correct orientation of the parts relative to each other. The braking mechanism 13 may also be used to lock the relative orientation between the stator and the rotor. The encoder or sensor may be chosen from commercially available solutions and will not be discussed in detail here.

FIG. 7 illustrates a variation of the embodiment in FIG. 5, where an air gap is introduced between shaft 2 and the rotor 12. In the illustrated example one coupling 4 is positioned at each end of the rotor. The couplings 4 comprising flange sections 9 outwards from the shaft and as discussed above, may be coupled to the rotor 12 using bolts 25. The couplings 4 can connect to the shaft e.g. by one or more segmented compression fittings connecting the segmented coupling to the shaft 2 by friction. An optional connection by bolted flange as illustrated in FIGS. 3 and 4a is possible. One or more segmented connection rings 35 allows for connecting the rotor 12 to the stator housing 15 by means of manual/semi-automatic or actuated connection 36 enabling the stator house to carry the weight and lock in position the rotor 12 and the coupling 4. The connection rings 35 may also include a breaking mechanism 13 of any known type, as illustrated in the previous figures, being configured to control the relative rotation between the rotor and stator. As illustrated the rotor is supported by two supports 2d,2e on a common platform 1b e.g. on a vessel. The supports 2e,2d are provided with splitted bearings which can be used to carry the weight of the rotor 12. The air gap and fixing, carrying and disconnection mechanism allows the shaft 2 to operate freely allowing for disengaging device 1 while not disturbing the main function of the shaft system 2,3. The air gap will limit the effect of shaft 2 lateral vibration and whirling to the 30 airgap between rotor segment 10 and stator segment 11.

In FIG. 7 an additional rotary sensor or encoder pair 20,21 integrated with one or more frequency converters 22 with its control algorithms is provided being capable of detecting and/or monitoring the relative movement and position between the rotor 12, couplings 4 and the shaft 2. This way the position relative to the rotor and shaft/coupling may be controlled or measured in order to stop and start the device. Thus, the movement of the rotor 12 may be initiated or disconnected at a predetermined relative position between the parts. Also, a rotational movement between the rotor and shaft/coupling may be detected, e.g. indicating broken pins, or monitored in order to connect the pins or bolts at the correct orientation of the parts relative to each other. A breaking mechanism 13 as shown in FIGS. 5 and 6 may also be used to lock the relative orientation between the stator and the rotor. In FIG. 7 the breaking mechanism is connected through pins or bolts 36 to a separate flange on the rotor part 12 The encoder or sensor 20,21 may be chosen from commercially available solutions and will not be discussed in detail here. The converter control 22 and sensors 20,21 can as an option control a turning gear/brake 23 of the main engine 3. The relative position can be controlled via a local operator panel (LOP).

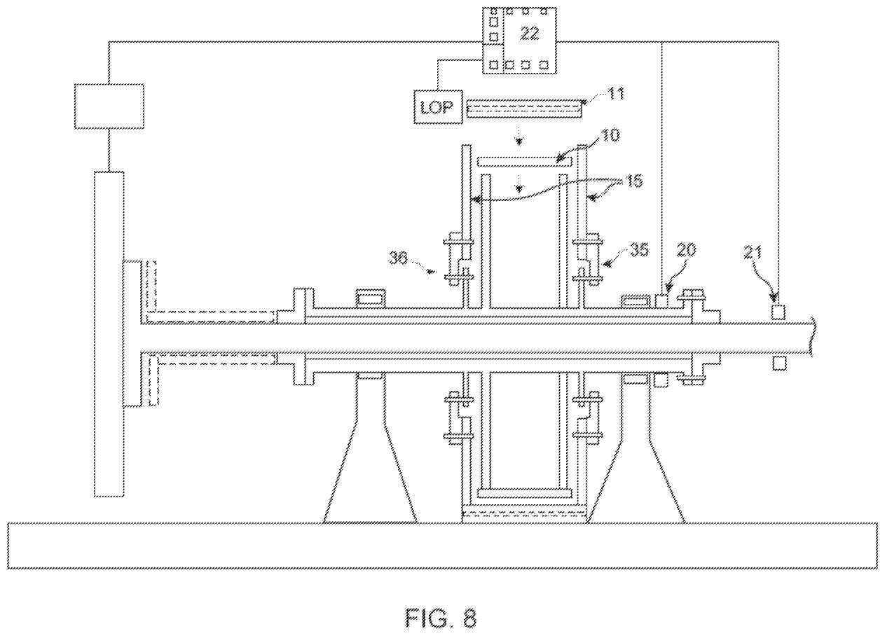

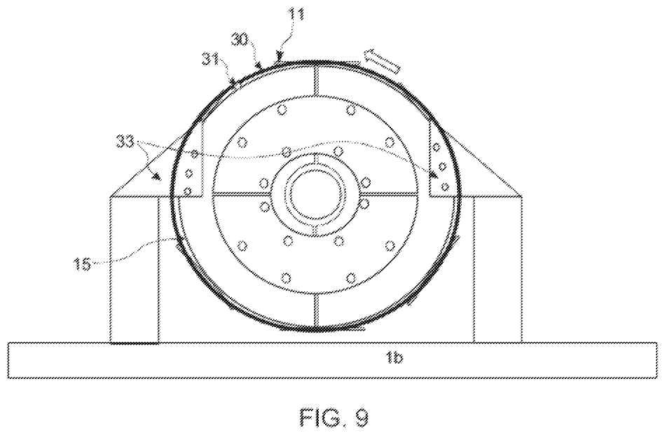

FIG. 8 illustrates how the position control enables segment installation from top in narrow areas. One by one stator segment and one by one rotor segment 10 can be installed sequentially from the top on the rotor support flanges, and one by one stator segment can be installed on stator housing permanent end shield structure 15 and segmented connections rings 35. Eventually the stator housing structure 15 can be fixed to a foundation be means of multi position generator feet 33, see FIG. 9.

FIG. 9 illustrates a method for stator installation above. A ring structure 30 positioned by a distributed rolling mechanism 31 placed on each of the stator housing structure 15 enable installation of stator segments 11 from top. The segmented ring structure 30 on the stator support ring or shield 15 allows for handling of all stator segments 11 from top to be installed or brought in installation position by the segmented ring structure 30. The complete assembled and rotatable stator is fixed to foundation 1b by fixed or multi position stator feet 33. The ring structure thus can carry segments 11 and manual or automated actuators allows for bringing the stator segments into position around the circle of the machine when all segments are in correct position coaxially around the stator housing carrying structure 15. The structure allows for dispatchment of stator segment upon frequency converter or sensor detection of segment failure and allows installation independent of the main system 2,3 as described below. A preferred installation method for the embodiment shown in FIGS. 7 is illustrated in FIG. 8 thus may for example involve the following steps:
1. Segmented supports 2d,e are first installed on a vessel or common device 1 foundation. The segmented supports allow for rotation.
2. The coupling parts 4a,4b (see FIG. 4b) are connected to the shaft 2.
3. The rotor 12 exclusive rotor segments 10 are assembled in the supports 2d,e
4. The rotor 12 is then connected to the couplings 4a,4b
5. The supports 2d, e top halves are assembled to secure the position of the rotor 12.
6. The assembly of the supports 2d,e, couplings 4 and rotor 12 (without rotor segment 10) are now rotatable by means of turning gear 3. As an alternative connection between coupling parts 4a,4b and 12 can be postponed in order to rotate the rotor assembly 12 (ex. 10) relative to the supports by conventional handling tools.
7. The assembly of the supports, 2d,e, shaft 2 and couplings 4, and rotor 12 (ex. 10) can then be aligned and balanced according to methods known in the art.
9. By turning gear or manual rotation, rotor segments 10 including segment outer protection, can be assembled on guiding pins on top of the flange of the rotor structure 12, fixed and rotated to next position for installation of the next rotor segment 10 including outer protection from top until the circular installation are complete.
10. The final circular rotor construction is then fixed, aligned and balanced according to methods known in the art.
11. Segmented connection rings 35 and connections 36 are connecting the segmented stator ring or shield 15 to stator shield locking flanges on rotor 12.
12. The rings 35, connections 36 and segmented stator ring or shields 15 are aligned according to methods known in the art.
13. By turning gear or manual rotation, stator segments 11 can be assembled on dedicated slots on top of the stator end shield structure 15, fixed and rotated to next position for installation of the next segment 11. As an option referred to as an alternative under step 7 the rotation can be achieved where the connection between the coupling parts and rotor have been postponed.
14. The final circular stator construction is then fixed with multi position feet 33, aligned and balanced according to methods known in the art. The rotor segment protections are removed during step 13 and 14.
15. Disconnection of the locking connections 36 allow for free turning of the rotor 12, shaft 2 and coupling 4 relative to the stator 11 and stator housing 15.
16. The process can be reversed for complete or partly by dispatch of a segment during failure or disassembly e.g. for maintenance.

Referring to FIGS. 8 and 9 the steps 13-16 may include the following: During step 13 the breaking mechanism 13, ring 35, connection 36 and stator shield 15 are fixed with stator feet to the vessel structure. Segmented installation rings 30 including a rolling mechanism 31 are installed around the stator house structure.

During step 14. By turning and positioning of installation ring 30, and rolling mechanism 31 the stator segments 11 can be assembled on dedicated slots on top of the ring shaped stator shield structure 15, fixed and rotated to next position for installation of the next segment 11.

During step 15 the final circular stator construction is then fixed to stator shields manually or by actuation mechanism. Stator is aligned according to methods known in the art. The rotor segment protections are removed during step 14 and 15.

After step 15 the disconnection of 36 allows for free turning of the rotor 12, shaft 2 and coupling 4 relative to the stator.

FIG. 10 illustrates an embodiment where the rotor 12 is separated in two rotor parts 12a, 12b in the longitudinal direction. Each part may have separate circuitry and magnets or other known rotor design principle 10a, 10b and bearings 2d,2e carries the weight of the parts together with coupling flanges 4a,4b, e.g. using compression fittings. The solution enables a main electrical machine with stator 11a) and first rotor part 12b, 10a having an additional independent inner electrical machine comprising of stator 11b and second rotor part 10b, 12a in a separate compartment inside the first rotor part 12b of the main electrical machine. The rotor and stators in separate chambers avoids any failure like short circuit to affect the complete functionality of the device. Utilizing the inner space of the rotor brings a compact fully redundant device. Both stators 11a, 11b may be water jacket cooled as mentioned above. The two electrical machines can be operated in parallel when both compression fittings are connected by friction to the separated coupling 4. Upon release of one of the two compression fittings, either the main electrical machine or the inner electrical machine can rotate the shaft independently. An additional rotary sensor or encoder 20b integrated with one or more frequency converters 22 with its control algorithms is provided being capable of detecting and/or monitoring the relative movement and position between the rotor part 12a, rotor rotor 12b and coupling segments 4a, b and the shaft 2. This way the position relative to the rotors and shaft/couplings may be controlled or measured in order to stop and start the device. Thus, the movement of the rotor may be initiated or disconnected at a predetermined relative position between the parts. Also, a rotational movement between the rotor and shaft/coupling may be detected, e.g. indicating broken pins or bolts, or monitored in order to connect the pins or bolts at the correct orientation of the parts relative to each other. The braking mechanisms 13a, 13b may also be used to lock the relative orientation between the stators and the rotors. The encoder or sensor may be chosen from commercially available solutions and will not be discussed in detail here.

To summarize the present invention relates to an electric device, specifically a generator or motor, for mounting on a rotatable shaft. The device comprises at least two rotor sections being configured to be combined coaxially around the shaft and being mechanically coupled to the shaft so as to constitute a rotor.

The device also includes at least two stator sections with housing configured to be combined in a coaxial stator configuration around said rotor.

The device also includes a coupling being fastened in a coaxial configuration to the shaft, where the coupling including a flange section extending outward from the shaft. The flange and rotor include matching locking sections so as to connect the rotor to the flange and therefore to the shaft. The coupling may also include an inner layer of soft metal to avoid fretting between the coupling and shaft.

The coupling is constituted by at least two sections being combined and fastened to each other and to the shaft.

The coupling, rotor and stator, as well as housing etc, may be contemplated in different forms and numbers, but in order to maintain symmetric load and wear they may preferably have similar sizes and shapes, preferably constituting three sections of substantially 120 degrees each.

The rotor may include a part that extends toward the shaft and possibly a distance along the shaft and includes at least one splitted bearing between the rotor and the shaft or coupling device.

The flange of the coupling may be fastened to the rotor, e.g. through a flange on the rotor, with bolts through the flange and rotor. The bolts may be constituted by shear pins configured to break at a predetermined force, so as to allow the coupling and the rotor to rotate relative to each other.

A sensing device such as a rotation sensor or encoder, may be provided being capable of detecting the rotational position or movement between the rotor and shaft, and/or between shaft and stator. The generator, rotor and/or stator may be configured to be activated or deactivated at a predetermined relative position between them for driving the device. At deviation between the intended movement and the detected movement, the rotor is inactivated, and an error is registered.

The device according to the invention may be part of a system where the device, when operating as a generator, is connected to a battery circuitry for storing the generated energy, and when being operated as an electric motor connected to a power supply.

As an alternative two couplings 4 are mounted on the shaft 2, the rotor 12 extending along the shaft between the couplings and having an inner dimension being larger than the shaft 2 so as to provide an airgap between the rotor and the shaft. As discussed above the couplings 4 connectors may be fixed to the shaft by segmented compression fittings, alternatively with flange/flywheel connection direct or via a connection.

The sensing devices 20,21 may be configured to detect the relative movement and position between the rotor/coupling and the shaft, where the device according to the invention may be controlled for manual, semi-automated or automated disconnection of the couplings, e.g. of compression fitting and flywheel flange, to or from the coupling with the rotor or when fixed to the stator by means of manual or actuated fixing arrangement in a brake mechanism or unit 13. It may also include an automated or local control 22 of a main engine turning gear 3 in order to position and lock the shaft line.

As illustrated in FIGS. 8 and 9 the invention may allow rotation of segmented flanged coupling for assembly of all rotor segments on to the flanges from top by rotating each installation area controlled in position.

As was discussed in relation to FIG. 9 the segmented stator support rings and provisional or permanent flange rings or rotatable rings on the stator support ring allows for handling of all stator segments from top to be installed or brought in installation position by a segmented ring structure. The complete assembled and rotatable stator can be fixed to foundation by multi position stator feet.

The external stator or internal rotor of the machine may be provided with water cooling and can turn the shaft by means of the existing main rotor or additional added rotor winding or poles inside the main rotor.

An inner hollow structure allows for an inside shaft through inner motor stator and flange connection to rotor(s) either at one or two sides of the device.

The rotor may alternatively be an elongated rotor extending along the shaft and one coupling connected to each end of the rotor, the rotor having an inner radius exceeding the radius of the shaft, thus providing an airgap between the shaft and rotor. In this case they may be rotatably supported by at least one supporting structure. In addition, the rotor may be divided in the longitudinal direction, each part being connected to one coupling and comprising one stator section for each rotor part.

According to another aspect the present invention relates to an electric machine for driving a rotatable shaft comprising at least two couplings being fastened in a coaxial configuration to the shaft, and an elongated rotor extending along the shaft and at each end being connected to a coupling to the shaft, the rotor being constituted by at least two rotor sections being configured to be combined coaxially around the shaft, the rotor dimensions being configured to provide a coaxial airgap between the rotor and the shaft, and wherein the machine comprises a stator being constituted by at least two stator sections with housing configured to be combined in a coaxial stator configuration around said rotor. As mentioned above the rotor is rotatably supported by at least one support structure.

According to yet another aspect of the invention the rotor may be split in two rotor parts in the longitudinal direction where each part having at least two stator sections configured to be combined in a coaxial stator configuration around said rotor, the rotor parts thus being configured to run independently of each other. The stator housing may enclose both stators with corresponding magnets or rotor segments. The rotor parts and rotor segments may have different dimensions and one of them men be position in a compartment inside the other, as illustrated in FIG. 10.

The present invention also relates to a method for assembling a machine or device as described above including the steps of
a) Mounting two couplings at a predetermined distance from each other to the shaft.
b) Assembling at least two rotor segments around the shaft.
c) Turning rotor segments to a new orientation for installation of the next rotor segment from top until the circular installation are complete.
d) Connecting segmented connection rings to a segmented stator shield and to the rotor while the connection rings and stator segments are mounted so that they may be rotated independently of the rotor.
e) Turning the stator shield and rotor to next position, where they may be rotated independent of each other, for installation of the next stator segment.
f) Disconnection of the locking connections to allow for free turning of the rotor 12 relative to the stator 11.

The connection between the rotor and couplings may either be provided in step b) or step f) depending on the situations. Step b) may also includes mounting outer rotor protections. The rotations are performed using a turning gear.

1. An electric device for mounting on a rotatable shaft, the electric device comprising:
at least two rotor sections configured to be combined coaxially around the shaft and mechanically coupled to the rotatable shaft so as to constitute a rotor;
at least two stator sections with housing configured to be combined in a coaxial stator configuration around the rotor; and
at least one coupling being fastened in a coaxial configuration to the rotatable shaft, the at least one coupling comprising matching locking sections so as to connect the rotor to the coupling and therefore to the rotatable shaft.

2. The electric device according to claim 1, wherein the coupling is constituted by at least two sections being combined and fastened to the rotatable shaft.

3. The electric device according to claim 2, wherein the electric device includes at least one splitted bearing between the rotor and the rotatable shaft or coupling device.

4. The electric device according to claim 1, wherein the at least one coupling coupling(s) includes a flange being fastened to the rotor.

5. The electric device according to claim 3, wherein the flange and rotor are fastened to each other with bolts through the flange and rotor.

6. The electric device according to claim 3, wherein the bolts are shear pins configured to break at a predetermined force, so as to allow the coupling and the rotor to rotate relative to each other.

7. The electric device according to claim 1, comprising a sensing device being configured to detect the rotational position or movement between the rotor and the rotatable shaft.

8. The electric device according to claim 7, wherein the rotor is configured to be activated or deactivated at a sensing of a predetermined relative position between the two for driving the electric device.

9. The electric device according to claim 7, wherein, at deviation between the intended movement and the detected movement, the rotor is inactivated and an error is registered.

10. The electric device according to claim 1, wherein the coupling is provided with a soft metal on the inner surface configured to be in contact with the rotatable shaft.

11. The electric device according to claim 1, wherein at least one of the rotor and the stator have at least three sections.

12. The electric device according to claim 1, comprising an elongated rotor extending along the rotatable shaft and one coupling connected to each end of the rotor, the rotor having an inner radius exceeding the radius of the rotatable shaft, thus providing an airgap between the rotatable shaft and the rotor.

13. The electric device according to claim 12, wherein the rotor is rotatably supported by at least one supporting structure.

14. The electric device according to claim 12, wherein the rotor is divided in the longitudinal direction, each part being connected to one coupling and comprising one stator section for each rotor part.

15. A system comprising a device according to claim 1, wherein the electric device comprises a generator connected to a battery circuitry for storing the generated energy.

16. The system comprising a device according to claim 1, wherein the electric device is an electric motor being connected to a power supply.

17. An electric machine for driving a rotatable shaft, the electric machine comprising:
at least two couplings being fastened in a coaxial configuration to the rotatable shaft;
an elongated rotor extending along the rotatable shaft and at each end being connected to a coupling thus to the rotatable shaft, the rotor being comprising at least two rotor sections configured to be combined coaxially around the rotatable shaft, the rotor dimensions configured to provide a coaxial airgap between the rotor and the rotatable shaft; and
a stator comprising at least two stator sections with housing configured to be combined in a coaxial stator configuration around the rotor.

18. The electric machine according to claim 17, wherein the rotor is rotatably supported by at least one support structure.

19. The electric machine according to claim 17, wherein the rotor is split in two rotor parts in the longitudinal direction, each part having at least two stator sections configured to be combined in a coaxial stator configuration around the rotor, the rotor parts thus being configured to run independently of each other.

20. The electric machine according to claim 19, wherein the stator housing encloses the stators.

21. A method for assembling a machine according to claim 17, comprising:
a) Mounting two couplings at a predetermined distance from each other to the rotatable shaft;
b) Assembling at least two rotor segments around the rotatable shaft;
c) Turning rotor segments to a new orientation for installation of the next rotor segment from top until the circular installation are complete;
d) Connecting segmented connection rings to a segmented stator shield and to the rotor;
e) Turning the stator shield and rotor to next position for installation of the next stator segment; and
f) disconnecting the locking connections to allow for free turning of the rotor relative to the stator.

22. The method according to claim 19, wherein step b) includes connecting the couplings to the rotor.

23. The method according to claim 19, wherein step f) includes connecting the couplings to the rotor.

24. The method according to claim 19, wherein the rotations are performed using a turning gear.

25. The method according to claim 19, wherein step b) includes mounting outer rotor protections.
